(19) United States
(12) Patent Application Publication
(10) Pub. No.: US 2025/0245665 A1
(43) Pub. Date: Jul. 31, 2025

(54) FRAUD RISK ANALYSIS SYSTEM INCORPORATING A LARGE LANGUAGE MODEL

(71) Applicant: ACTIMIZE LTD, Ra'anana (IL)

(72) Inventors: Sunny THOLAR, Pune (IN); Sumit KUMAR, Pune (IN); Manish GULRANDHE, Pune (IN)

(21) Appl. No.: 18/425,838

(22) Filed: Jan. 29, 2024

(51) Int. Cl. G06Q 20/40; G06F 16/242

(52) U.S. Cl. CPC G06Q 20/4016; G06F 16/243

(57) ABSTRACT

A system is adapted to automatically report the trustworthiness of an entity. The system includes a processor and a computer readable medium carrying instructions. The instructions include receiving unstructured data pertaining to an entity from public sources, and receiving structured data pertaining to the entity from at least two databases. The instructions also include merging the structured data and the unstructured data into a single document; splitting the single document into chunks; creating embeddings corresponding to the chunks; and storing the embeddings in a vector store. The instructions also include receiving a natural language user query regarding trustworthiness of the entity; converting the query to a query embedding; based on the query embedding and a similarity calculation, fetching a relevant embedding from the vector store; with a large language model (LLM), generating a query response regarding the trustworthiness of the entity; and communicating the query response to the user.

### COPYRIGHT NOTICE

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### TECHNICAL FIELD

The subject matter described herein relates to devices, systems, and methods for analyzing fraud risk. This fraud investigation digital assistant system has particular but not exclusive utility for anti-money-laundering (AML) investigations.

### BACKGROUND

An anti-money-laundering (AML) investigation is the formal analysis of suspicious activities to determine if customers or other persons or entities are using the financial institution in question for money laundering purposes. Today's problem is excess data, staggered across multiple sources and formats, and how to efficiently handle and evaluate such data. Large volumes of data spread across different source systems make AML investigations complex, time-consuming and resource-intensive, thus driving high costs and slow response times. The same is true for investigation of other types of fraud or financial crimes investigation.

For credit unions in the United States, the estimated total burden of filing suspicious activity reports (SARs) in the year 2020 was 343,972 hours per year, and the estimated total annual cost was $12,843,002 per year. For banks in the United States, the estimated total annual burden was 2,854,613 hours with an estimated total annual cost of $107,803,688 per year. Most of this time is spent in gathering information and then presenting the information in the form of a narrative.

Accordingly, a need exists for improved fraud analysis and suspicious activity monitoring tools that address the forgoing and other concerns.

The information included in this Background section of the specification, including any references cited herein and any description or discussion thereof, is included for technical reference purposes only and is not to be regarded as subject matter by which the scope of the disclosure is to be bound.

### SUMMARY

To improve investigation times and outcomes, information related to a suspicious customer can be made readily available to the fraud investigator in easily comprehended, natural-language formats. A fraud investigation digital assistant system is disclosed, that can understand questions, find or search for answers, and complete the user's intended action through a conversational large language model (LLM) that can be trained on an enormous dataset. The dataset includes personally identifying information (PII) about an entity, including details from “know your customer” (KYC), profile information, transaction data, and data related to alerts and issues for the entity. The entity may for example be a natural person, or may be an organization. The dataset also includes external data sources, including sources that are publicly accessible over the Internet.

The fraud investigation digital assistant system disclosed herein has particular, but not exclusive, utility for anti-money-laundering (AML) investigations. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a system adapted to automatically report the trustworthiness of an entity. The system also includes a processor and a computer readable medium operably coupled thereto, the computer readable medium may include a plurality of instructions stored in association therewith that are accessible to, and executable by, the processor, to perform operations which may include: receiving unstructured data pertaining to an entity from a plurality of public sources, and receiving structured data pertaining to the entity from at least two of: a database may include data for multiple software applications, a suspicious activity monitoring (SAM) database, a client due diligence (CDD) database, a watch list filtering (WLX) database, or a risk case management (RCM) database. The operations also include, with a merging engine, merging the structured data and the unstructured data into a single document. The operations also include, with a semantic analyzer, splitting the single document into a plurality of chunks; with an embedding model, based on the plurality of chunks, creating a plurality of embeddings, each embedding corresponding to a chunk of the plurality of chunks; and storing the plurality of embeddings in a vector store. The operations also include receiving a natural language user query regarding trustworthiness of the entity; with the embedding model, converting the natural language user query to a query embedding; based on the query embedding and a similarity calculation, fetching a relevant embedding from the vector store; with a large language model (LLM), based on the query embedding, the fetched relevant embedding, and the chunk corresponding to the fetched embedding, generating a query response regarding the trustworthiness of the entity. The instructions also include communicating the query response to the user. Other embodiments of this aspect include corresponding computer systems, apparatus, and computer programs recorded on one or more computer storage devices, each configured to perform the actions of the methods.

Implementations may include one or more of the following features. In some embodiments, the similarity calculation may include a cosine similarity calculation. In some embodiments, the entity may include a person. In some embodiments, the public sources are accessed over the internet. In some embodiments, the plurality of public sources may include at least one of a document, a website, an encyclopedia, a database, a search engine, a map, a weather report, or a news report. In some embodiments, the structured data may include personally identifying information (PII) about the entity. In some embodiments, generating the query response regarding the trustworthiness of the entity involves the chat history. In some embodiments, the system may include: with the LLM, based on the user query and the chat history, constructing a standalone question; and substituting the standalone question for the user query. In some embodiments, the query response may include a natural language response. In some embodiments, the operations further may include: based on the query embedding and a similarity calculation, fetching a plurality of relevant embedding from the vector store; and with the large language model (LLM), based on the query embedding, the fetched plurality of relevant embeddings, and the respective chunks corresponding to the fetched embeddings, generating the query response regarding the trustworthiness of the entity, where the query response may include a summary of the respective chunks. Implementations of the described techniques may include hardware, a method or process, or computer software on a computer-accessible medium.

One general aspect includes a computer-implemented method adapted to automatically generate and validate rules for monitoring suspicious activity. The computer-implemented method includes receiving unstructured data pertaining to an entity from a plurality of public sources. The method also includes receiving structured data pertaining to the entity from at least two of: a database including data for multiple software applications, a suspicious activity monitoring (SAM) database, a client due diligence (CDD) database, a watch list filtering (WLX) database, or a risk case management (RCM) database. The method also includes, with a merging engine, merging the structured and unstructured data into a single document. The method also includes, with a semantic analyzer, splitting the single document into a plurality of chunks. The method also includes, with an embedding model, based on the plurality of chunks, creating a plurality of embeddings, each embedding corresponding to a chunk of the plurality of chunks. The method also includes storing the plurality of embeddings in a vector store. The method also includes receiving a natural language user query regarding trustworthiness of the entity. The method also includes with the embedding model, converting the natural language user query to a query embedding. The method also includes, based on the query embedding and a similarity calculation, fetching a relevant embedding from the vector store. The method also includes, with a large language model (LLM), based on the query embedding, the fetched relevant embedding, and the chunk corresponding to the fetched embedding, generating a query response regarding the trustworthiness of the entity. The method also includes communicating the query response to the user. Other embodiments of this aspect include corresponding computer systems, apparatus, and computer programs recorded on one or more computer storage devices, each configured to perform the actions of the methods.

Implementations may include one or more of the following features. In some embodiments, the similarity calculation may include a cosine similarity calculation. In some embodiments, the entity may include a person. In some embodiments, the public sources are accessed over the internet. In some embodiments, the plurality of public sources may include at least one of a document, a website, an encyclopedia, a database, a search engine, a map, a weather report, or a news report. In some embodiments, the structured data may include personally identifying information (PII) about the entity. In some embodiments, generating the query response regarding the trustworthiness of the entity involves the chat history. In some embodiments, the method may include: with the LLM, based on the user query and the chat history, constructing a standalone question; and substituting the standalone question for the user query. In some embodiments, the query response may include a natural language response. In some embodiments, the query response may include a summary of the respective chunks. Implementations of the described techniques may include hardware, a method or process, or computer software on a computer-accessible medium.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of the fraud investigation digital assistant system, as defined in the claims, is provided in the following written description of various embodiments of the disclosure and illustrated in the accompanying drawings.

### BRIEF DESCRIPTION OF THE DRAWINGS

Illustrative embodiments of the present disclosure will be described with reference to the accompanying drawings, of which:

FIG. 1 is a schematic, diagrammatic representation of an example fraud investigation digital assistance method, according to at least one embodiment of the present disclosure.

FIG. 2 is a schematic, diagrammatic representation of a document being split into chunks, according to at least one embodiment of the present disclosure.

FIG. 3 is a schematic, diagrammatic representation of a vectorization or embedding process, according to at least one embodiment of the present disclosure.

FIG. 4 is a schematic, diagrammatic representation, in block diagram form, of a data ingestion subsystem for an example fraud investigation digital assistant system, according to at least one embodiment of the present disclosure.

FIG. 5 is a schematic, diagrammatic representation, in block diagram form, of at least a portion of an example fraud investigation digital assistant system, according to at least one embodiment of the present disclosure.

FIG. 6 is a schematic, diagrammatic representation, in block diagram form, of at least a portion of an example fraud investigation digital assistant system, according to at least one embodiment of the present disclosure.

FIG. 7 is a schematic, diagrammatic representation, in block diagram form, of at least a portion of an example large language model (LLM) training subsystem, according to at least one embodiment of the present disclosure.

FIG. 8 is a screen display of an example large language model (LLM) training subsystem, according to at least one embodiment of the present disclosure.

FIG. 9 is a schematic, diagrammatic representation, in block diagram form, of a suspicious activity monitoring (SAM) system, according to at least one embodiment of the present disclosure.

FIG. 10 is a screen display of an example fraud investigation digital assistant system, according to at least one embodiment of the present disclosure.

FIG. 11 is a screen display of an example fraud investigation digital assistant system, according to at least one embodiment of the present disclosure.

FIG. 12 is a schematic diagram of a processor circuit, according to at least one embodiment of the present disclosure.

### DETAILED DESCRIPTION

To improve investigation times and outcomes, information related to a suspicious customer can be made readily available to the fraud investigator in easily comprehended, natural-language formats. In that regard, a fraud investigation digital assistant system is disclosed, that can understand questions, find or search for the best answers, and complete the user's intended action through conversational AI. A key component is a large language model (LLM) that can be trained on an enormous dataset (e.g., using LangChain, an open-source developer framework for building LLM applications). The dataset includes personally identifying information (PII) about an entity, including details from “know your customer” (KYC) disclosures, profile information, transaction data, and data related to alerts and issues for the entity. The entity may for example be a natural person, or may be an organization. The dataset also includes external data sources, including sources that are publicly accessible over the Internet. Setting up an LLM for fraud investigation involves two components: ingestion of the data, and retrieval of the data.

Ingested data generally includes structured and unstructured data. Structured data can come from databases internal to a fraud management organization, including but not limited: to a database comprising data for multiple software applications; a suspicious activity monitoring (SAM) database; a client due diligence (CDD) database; a watch list filtering (WLX) database; or a risk case management (RCM) database. Unstructured data can come from private sources and more often from one or more publicly available sources, including but not limited to documents, websites, online encyclopedias, databases, search engines, mapping or navigation services, weather reporting services, or news reporting services.

With a merging engine, the fraud investigation digital assistant merges the structured data and the unstructured data into a single document and then, with a semantic analyzer, splits the single document into a large number of chunks (e.g., by parsing for keywords and/or based on length). With an embedding model, the fraud investigation digital assistant then creates embeddings from the chunks, with each embedding corresponding to one chunk of the single document. An embedding is a vector representation of the text of a chunk, that captures the content and/or meaning of the chunk. Text with similar content will have similar vectors. The embeddings are then stored in a vector store, thus completing the ingestion process.

The retrieval of data begins with a natural language query from a user. The user may for example be a fraud investigator who has received an alert regarding the entity, and the query may be any natural-language question relating to the trustworthiness of the entity. Depending on the implementation, the fraud investigation digital assistant may reject questions that do not relate to the trustworthiness of an alerted entity. With the embedding model, the fraud investigation digital assistant then converts the natural language user query to a query embedding, and then fetches a relevant embedding from the vector store based on a similarity calculation (e.g., a cosine similarity calculation).

Next, with a large language model (LLM), based on the query embedding, the fetched relevant embedding, and the chunk corresponding to the fetched embedding, the fraud investigation digital assistant described herein generates a query response. Since the query related to the trustworthiness of an alerted entity, the response also relates to the trustworthiness of the alerted entity. The fraud investigation digital assistant then communicates the query response to the user, for example as natural-language text in a chat window, although other forms of communication can be used instead or in addition, including graphs, images, or natural-language speech.

Depending on the implementation, the fraud investigation digital assistant may also maintain a chat history, which may be used by the LLM in generating the response, and which is then used by the LLM to construct a standalone question from the user query, and substitute the standalone question for the user query. For example, the fraud investigation digital assistant may add one or more of context, formatting, instructions or other information to the user query to affect the quality or level of detail in the LLM's response to the user query.

In a more general sense, based on the query embedding and the similarity calculation, the fraud investigation digital assistant may fetch multiple relevant embeddings from the vector store. This may result in a longer or more detailed response by the LLM to the user query, that includes information from many or all of the chunks associated with the fetched embeddings. Alternatively, depending on the wording of the user query and/or the context or other information in the standalone question, the LLM may summarize the chunks associated with the multiple embeddings in order to form the query response.

Depending on the implementation, the fraud investigation digital assistant may be a standalone application, or may be integrated into other fraud management or fraud investigation applications (e.g., as a chat window).

Thus, in inference mode or daily usage (e.g., after data ingestion), the fraud investigation digital assistant is preloaded with a large amount of relevant context about the alerted party or entity. Thus, the fraud investigation digital assistant can facilitate money laundering investigations in several ways. One such example is evidence gathering; the fraud investigation digital assistant can gather and analyze transactional activity and other information about customers, and has the potential to gather third-party intelligence about customers (e.g., negative news reports, location details, etc.). In a non-limiting example, the zip code of the entity may be associated with a number of negative news reports regarding financial crimes-a fact which may be difficult for a human fraud investigator to uncover, but which may emerge naturally from the LLM based on similarity of data chunks to the wording of the user query or the standalone question (e.g., cosine similarity of the query embedding to embeddings in the vector store).

Furthermore, the fraud investigation digital assistant can automate repetitive tasks involved in money laundering investigations, including but not limited to transactional analysis, KYC document review, and communications with customers. Advantages of the fraud investigation digital assistant include cost savings, faster operational processes, optimized team efficiency, less training overhead, increased accuracy, and improved audit trails for the fraud investigation process. The fraud investigation digital assistant can also generate a detailed summary of chat interactions that can be used to build suspicious activity report (SAR) narratives. This in turn allows investigators focus on more complex and demanding tasks that require human attention.

Thus, the fraud investigation digital assistant system disclosed herein is not an ordinary, general-purpose chatbot. Along with giving 360-degree view of an alerted entity (e.g., a person or organization), the fraud investigation digital assistant system can automate most of the processes on an investigator's checklist, such as address validation, data gathering, generating a customized SAR narrative, etc., or any combination thereof. The fraud investigation digital assistant system is a special-purpose alert investigation agent which can fetch data from multiple internal and external sources, and can leverage large language model (LLM) capabilities to generate helpful responses tailored to suspicious activity monitoring and reporting. Hence, the fraud investigation digital assistant system of this disclosure is unique in a way that will help investigators to investigate the alerts more efficiently and in lesser time.

The present disclosure aids substantially in the investigation of suspicious financial activity, by improving the gathering of data and its organization into a natural-language narrative form. Implemented on a processor in communication with one or more databases, and with external unstructured data sources, the fraud investigation digital assistant system disclosed herein provides practical, real-time enhancement of the capabilities of a fraud analyst. This augmented analysis capability transforms data that is spread globally, across multiple sources and formats, into natural-language formatted answers, summaries, and reports, without the normally routine need to expend hours of human labor. This unconventional approach improves the functioning of the suspicious activity monitoring (SAM) computer system, by enabling it to receive SAM-related questions about an entity, and give detailed answers about the entity, in a natural-language format. The fraud investigation digital assistant system also improves the functioning of the computer by ensuring that information regarding the entity is compiled from all available data sources rather than just the ones an analyst thinks to check and has sufficient time to do so. This results not only in time savings, but in higher-quality reporting at speeds impossible for a human analyst acting alone.

The fraud investigation digital assistant system may be implemented as a process at least partially viewable on a display, and operated by a control process executing on a processor that accepts user inputs from a keyboard, mouse, or touchscreen interface, and that is in communication with one or more databases. In that regard, the control process performs certain specific operations in response to different inputs or selections made at different timed. Outputs of the fraud investigation digital assistant system may be printed, shown on a display, or otherwise communicated to human operators. Certain structures, functions, and operations of the processor, display, sensors, and user input systems are known in the art, while others are recited herein to enable novel features or aspects of the present disclosure with particularity.

These descriptions are provided for exemplary purposes only, and should not be considered to limit the scope of the fraud investigation digital assistant system. Certain features may be added, removed, or modified without departing from the spirit of the claimed subject matter.

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

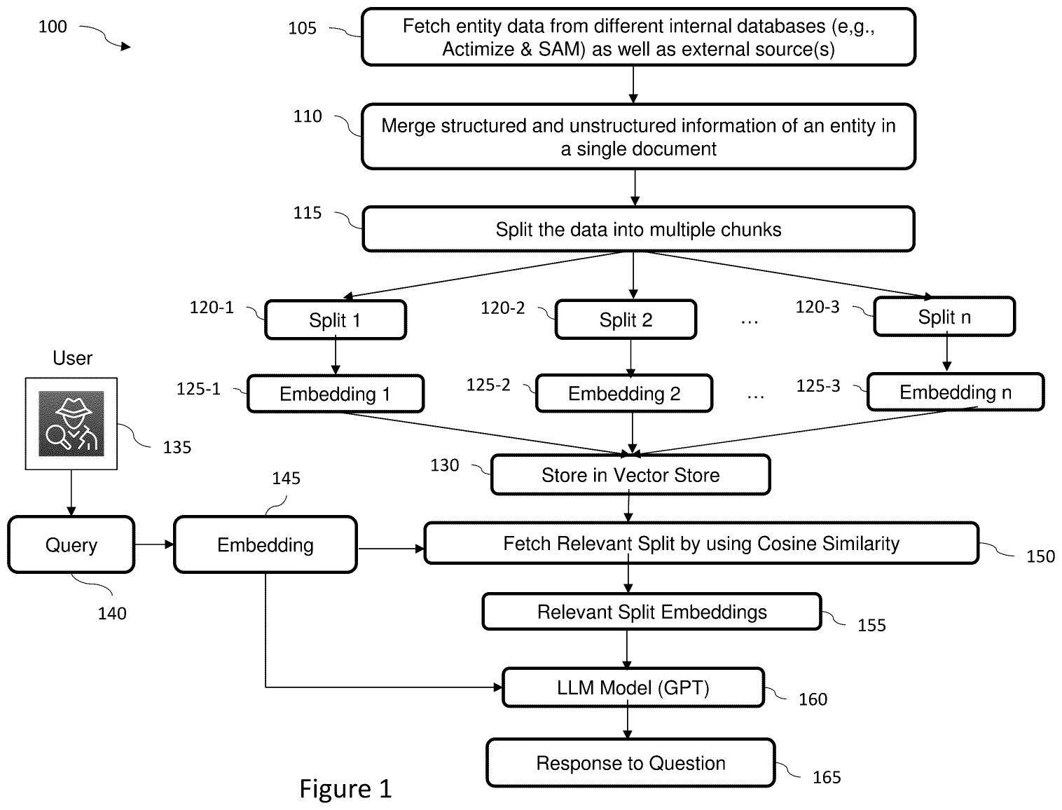

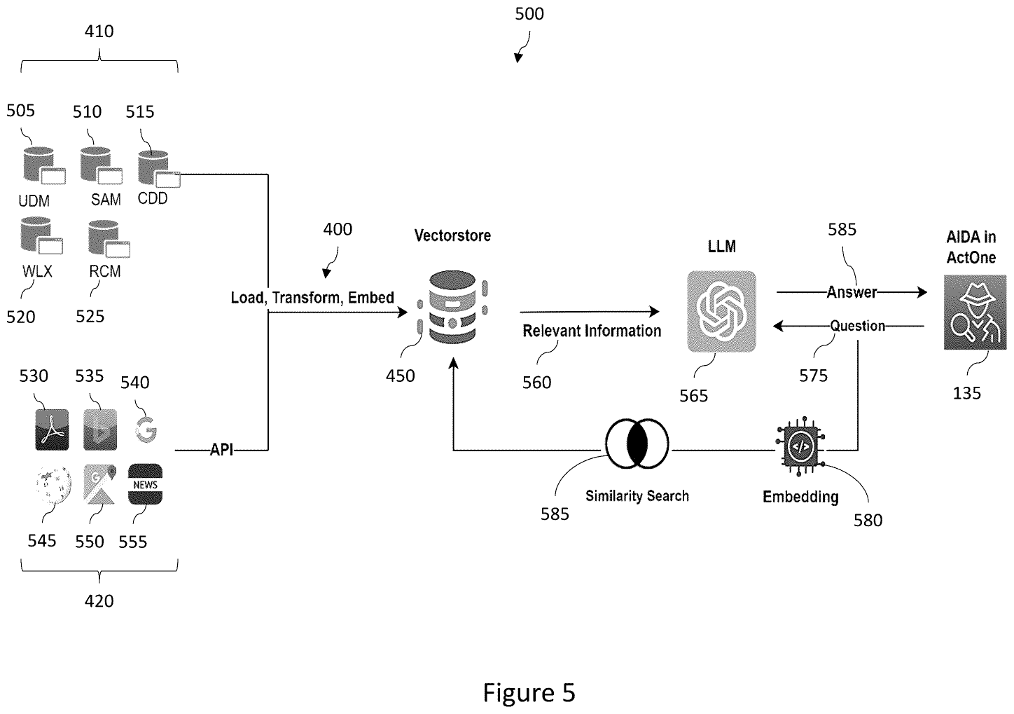

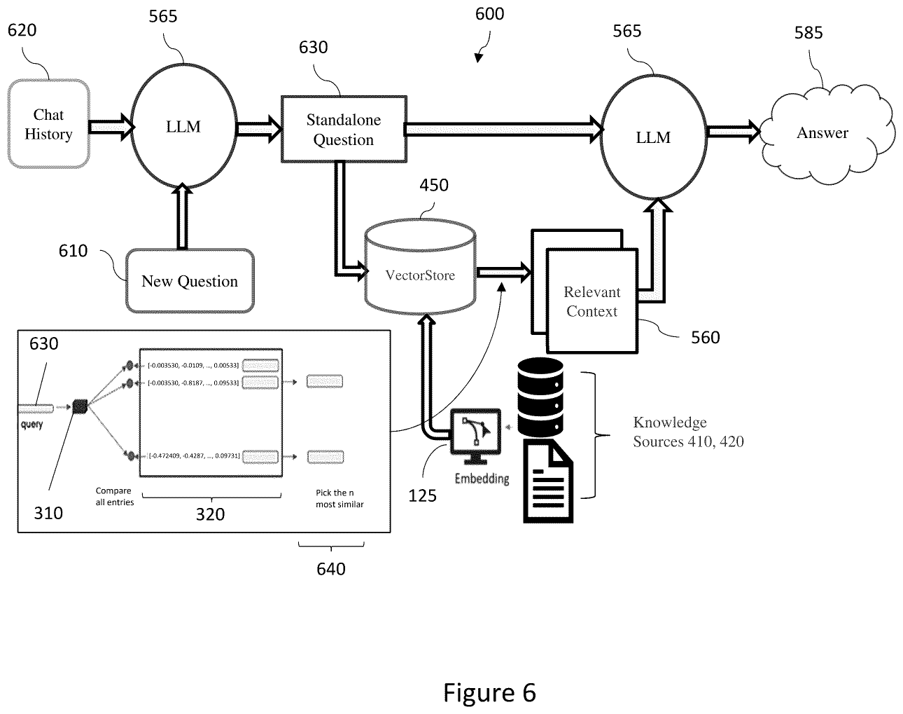

FIG. 1 is a schematic, diagrammatic representation of an example fraud investigation digital assistance method 100, according to at least one embodiment of the present disclosure. It is understood that the steps of method 100 may be performed in a different order than shown in FIG. 1, additional steps can be provided before, during, and after the steps, and/or some of the steps described can be replaced or eliminated in other embodiments. One or more of steps of the method 100 can be carried by one or more devices and/or systems described herein, such as components of system 500 (see FIG. 5), system 600 (see FIG. 6), and/or processor circuit 1250.

In step 105, the method 100 includes fetching structured data about an entity from multiple local or proprietary databases, and fetching unstructured data about the entity from external or publicly available sources, as described below in FIG. 5. Execution then proceeds to step 110.

In step 110, the method 100 includes with a merging engine, merging the structured and unstructured data. In some cases, the structured and unstructured data are merged into a single document, although multiple documents may be used instead or in addition. Execution then proceeds to step 115.

In step 115, the method 100 includes, with a semantic analyzer, splitting the data from the single document into multiple splits or chunks 120, and, with an embedding model, vectorizing each chunk 120 (e.g., chunks 120-1, 120-2, 120-3) into an embedding 125 (e.g., embeddings 125-1, 125-2, 125-3). Execution then proceeds to step 130.

In step 130, the method 100 includes storing the embeddings 125 in a vector store. Execution then proceeds to step 150.

In step 140, the method 100 includes receiving a natural language query from a user 135. Execution then proceeds to step 145.

In step 145, the method 100 includes, with an embedding model, vectorizing the user query 140. Execution then proceeds to step 150.

In step 150, the method 100 includes fetching relevant splits or chunks 120 by using cosine similarity to determine which chunks 120 are sufficiently similar to the user query. Sufficient similarity may for example mean similarity within a threshold value, or selecting the “n” most similar vectors from the vector store, and fetching their associated chunks. Execution then proceeds to step 155.

In step 105, the method 100 includes feeding the relevant embeddings into a large language model (LLM), which generates a response 165 to the user query. The method 100 is now complete.

Flow diagrams and block diagrams are provided herein for exemplary purposes; a person of ordinary skill in the art will recognize myriad variations that nonetheless fall within the scope of the present disclosure. For example, any of the steps described herein may optionally include an output to a user of information relevant to the step, and may thus represent an improvement in the user interface over existing art by providing information not otherwise available. The fraud investigation digital assistant system itself represents a significant improvement to current user interfaces by providing a natural-language chat interface for accessing and summarizing information from disparate sources.

Similarly, the logic of flow diagrams may be shown as sequential. However, similar logic could be parallel, massively parallel, object oriented, real-time, event-driven, cellular automaton, or otherwise, while accomplishing the same or similar functions. In order to perform the methods described herein, a processor may divide each of the steps described herein into a plurality of machine instructions, and may execute these instructions at the rate of several hundred, several thousand, several million, or several billion per second, in a single processor or across a plurality of processors. Such rapid execution may be necessary in order to execute the method in real time or near-real time as described herein. For example, to respond in real time to a user query about an alerted entity may require fetching, merging, vectorizing, storing, and comparing data related to the entity from potentially thousands of sources, and feeding relevant embeddings to an LLM, within less than one second. Such actions could not be performed in the human mind or by existing LLM or chatbot systems.

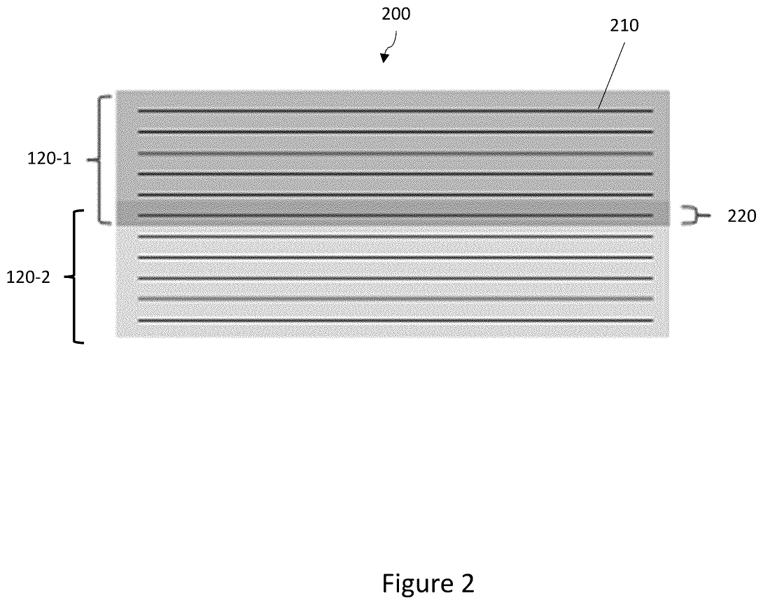

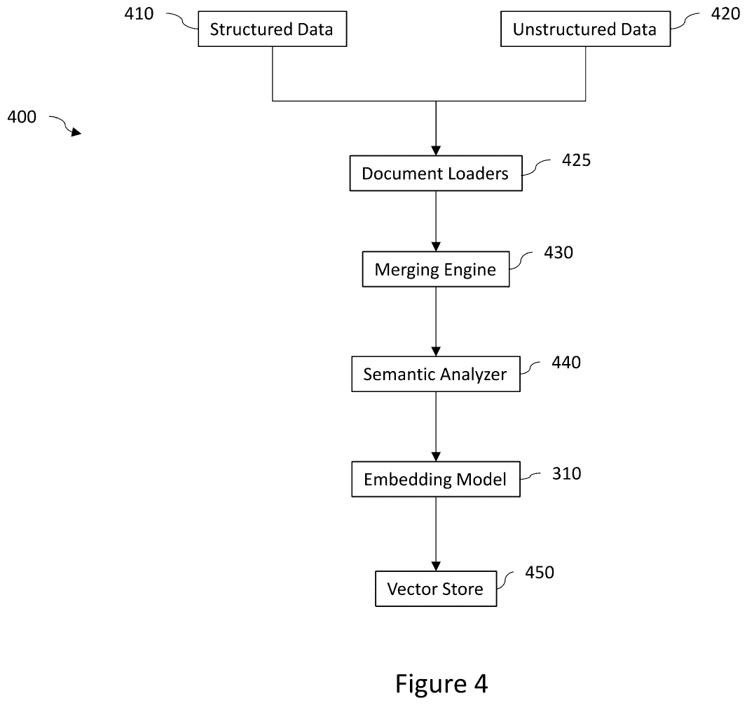

FIG. 2 is a schematic, diagrammatic representation of a document 200 being split into chunks 120-1 and 120-2, according to at least one embodiment of the present disclosure. In the example shown in FIG. 2, the document 200 is split into two chunks, 120-1 and 120-2, each including multiple lines 210 of text. Depending on the chunking algorithm used (see FIG. 4, below), there may be one or more lines of overlap 220 between chunks.

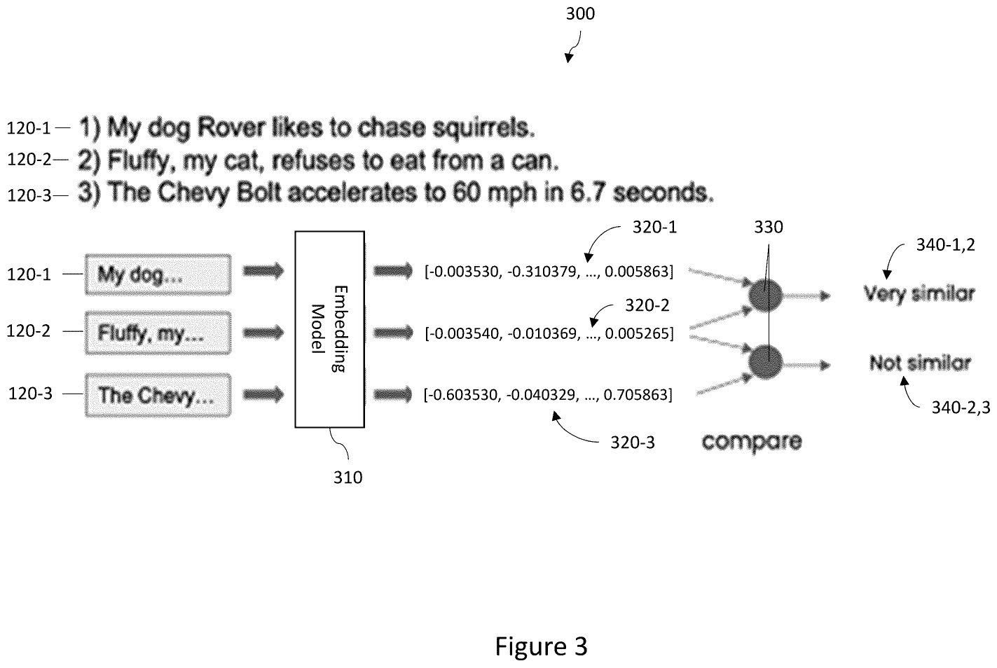

FIG. 3 is a schematic, diagrammatic representation of a vectorization or embedding process 300, according to at least one embodiment of the present disclosure. In the example shown in FIG. 3, three chunks 120-1, 120-2, 120-3 are fed into an embedding model 310, which turns them into embeddings 320-1, 320-2, 320-3. In this context, an embedding is a vector representation of the text in the chunk, with each element of the vector representing a word or concept in the chunk, and/or the relationship of a word or concept to other words or concepts. The vectorization or embedding process is discussed in greater detail in FIG. 4, below.

Embeddings can be compared using a comparator or compare step 330, such as a cosine similarity comparison. In the example shown in FIG. 3, chunks 120-1 and 120-2 both relate to the behavior and preferences of a pet, and so a comparison 340-1,2 of chunks 120-1 and 120-2 shows them to be very similar. This may be reflected for example with a relatively large (e.g., close to 1.0) numerical value from the cosine similarity calculation, where a value of 1.0 indicates that the two vectors are identical, 0.0 indicates that the vectors are orthogonal (e.g., not similar), and −1.0 indicates that the vectors are diametrically opposed (completely dissimilar). Conversely, chunks 120-3 related to the performance characteristics of a vehicle, and so a comparison 340-2,3 between chunks 120-2 and 120-3 will show then to be not similar. This may be reflected for example by a relatively small (e.g., close to zero) numerical value from the cosine similarity calculation. Such vector comparisons can therefore be used to determine the relevance of one embedding (e.g., fetched data from the vector store) to another embedding (e.g., a vectorized form of a user query).

FIG. 4 is a schematic, diagrammatic representation, in block diagram form, of a data ingestion subsystem 400 for an example fraud investigation digital assistant system, according to at least one embodiment of the present disclosure. The data ingestion subsystem includes takes in structured data 410 and unstructured data 420, and includes document loaders 420, a merging engine 430, a semantic analyzer 440, an embedding model 310, and a vector store 450.

To create an application where investigator can chat with local/proprietary/structured data and external/public/unstructured data, the fraud investigation digital assistant system first needs to load data from different sources. This can be accomplished using document loaders 425, which may for example be LangChain document loaders. LangChain is an open-source tool for creating and operating LLMs, and supports more than 80 different types of document loaders 425.

Document loaders 425 deal with the specifics of accessing and converting data from a variety of different formats and sources into a standardized format. There can be different sources for the data, including for example: websites, different databases, YouTube, etc., and these documents can come in different data types, like PDFs, HTML, JSON, etc. The purpose of document loaders 425 is to take this variety of data sources and load them into a standard document object.

Documents can be in structured data 410 as well as unstructured data 420. Some examples of structured documents are databases, comma-separated value (CSV) files, and JavaScript object notation (JSON) files, and examples of unstructured data include emails, social media posts, news reports, etc. These can be accessed using a variety of methods, such as loading them from a file or a database.

Here is an example of how text can be loaded our documents from a directory of text files:

```
import os
import langchain
documents = [ ]
for filename in os.listdir(‘documents’):
  with open(os.path.join(‘documents’, filename), ‘r’) as f:
    documents.append(f.read( ))
```

The loaded data is then merged with a merging engine 430 into a single document. In some embodiments, the merging engine 430 may be part of the document loaders 425.

Document chunking is performed with a chunker or semantic analyzer 440, to split the single document into different chunks, because LLMs can only process a limited amount of text at a time.

There are many different ways to chunk documents, including but not limited to:

### 1. Fixed-Size Chunking:

This is the simplest and most common approach. It involves dividing the document into chunks of a fixed size, typically measured in characters or tokens. This method is easy to implement and computationally efficient, but it can break sentences and paragraphs in half, which may affect the semantic coherence of the chunks.

### 2. Sliding Window Chunking:

This approach involves moving a window of fixed size along the document, creating chunks that overlap with each other. This method helps to preserve the semantic coherence of the chunks, but it can generate a large number of overlapping chunks, which can increase processing time.

### 3. Sentence Chunking:

This approach splits the document into sentences, using sentence segmentation algorithms. This method preserves the semantic coherence of the chunks, but it can be computationally expensive, especially for long documents.

### 4. Paragraph Chunking:

This approach splits the document into paragraphs, using paragraph segmentation algorithms. This method is less computationally expensive than sentence chunking, but it may not preserve the semantic coherence of the chunks as well.

### 5. Recursive Character Chunking:

This approach recursively splits the document based on a set of characters, such as newlines, spaces, and punctuation marks. This method is designed to keep paragraphs, sentences, and words together as much as possible, but it can be more complex to implement than other methods.

### 6. Custom Chunking:

Custom chunking strategies can be based on the specific needs of an application and/or the characteristics of particular data. For example, a combination of fixed-size chunking and sentence chunking can be used to balance efficiency and semantic coherence.

The best chunking strategy depends on the specific characteristics of the data, and on the downstream tasks being performed on it. In an example, the fraud investigation digital assistant system uses the paragraph chunking method.

Here is an example of how to chunk documents into paragraphs:
chunked_documents=[ ]
for document in documents:
chunked_documents.extend(langchain.chunk_text(document, chunk_size=1024))

Once the data has been chunked, the next step is to use an embedding model 310 to embed text into a numerical format that the LLM can understand. This can be done using a variety of embedding methods, such as OpenAI's Embeddings. In the context of LangChain, embeddings are numerical representations of words, phrases, or documents that capture their semantic meaning. These embeddings allow the LangChain large language model (LLM) to understand the relationships between words and concepts, which aids in tasks such as natural language understanding, translation, and text generation.

There are two main types of embeddings used in LangChain:

Word embeddings: These embeddings represent individual words. They are typically generated using techniques such as word2vec or GloVe, which analyze large amounts of text data to learn the relationships between words.

Document embeddings: These embeddings represent entire documents. They are typically generated by averaging the word embeddings of the words in the document. This captures the overall meaning of the document.

Embeddings are used in several ways in Langchain:

Training the LLM: Embeddings are used as input to the LLM during training. The LLM learns to associate the embeddings with the corresponding words or documents, which allows it to understand the meaning of the text.

Performing natural language processing (NLP) tasks: Embeddings can be used to perform a variety of NLP tasks, such as sentiment analysis, topic modeling, and question answering.

Creating new text formats: Embeddings can be used to create new text formats, such as poems, code, scripts, musical pieces, emails, letters, etc.

Embeddings are a powerful tool for understanding and generating text, and they major component of the LangChain LLM.

LangChain uses by default word embeddings. Here is an example of how text can be embedded using OpenAI's Embeddings:

import openai
openai.api_key = your_openai_api_key
embeddings = [ ]
for chunk in chunked_documents:
embeddings.append(openai.Embedding.create(chunk))

The final step in the data ingestion process is generally to store the embeddings in a vector store 450. This can be done using a variety of vector stores, such as Chroma vector store. In the context of LangChain, a vector store is a data storage system that is specifically designed for storing and retrieving vector representations of data. Vector representations are numerical representations of data, such as text, images, or audio, that can be used by machine learning algorithms to understand the meaning of the data.

Vector stores are important for LangChain because they allow the LLM to efficiently load and access the data that it needs to generate text, translate languages, write different kinds of creative content, and answer questions in an informative way.

LangChain supports a variety of vector stores, including:

In-memory vector stores: These vector stores store the vector representations of the data in memory. This makes them very fast, but they can also be memory intensive.

Database-backed vector stores: These vector stores store the vector representations of the data in a database. This makes them more scalable than in-memory vector stores, but they can also be slower.

Cloud-based vector stores: These vector stores store the vector representations of the data in the cloud. This makes them very scalable and easy to use, but they can also be more expensive than other types of vector stores.

The choice of vector store depends on several factors, such as the amount of data that needs to be stored, the performance requirements of the application, and the budget.

In an example, the fraud investigation digital assistant system uses a chroma vector store. Here is an example of how to store embeddings in chroma vector store:

import chromadb
vector_store = chromadb.VectorStore(‘chromadb’)
vector_store.add_many(embeddings)

Block diagrams are provided herein for exemplary purposes; a person of ordinary skill in the art will recognize myriad variations that nonetheless fall within the scope of the present disclosure. For example, block diagrams may show a particular arrangement of components, modules, services, steps, processes, or layers, resulting in a particular data flow. It is understood that some embodiments of the systems disclosed herein may include additional components, that some components shown may be absent from some embodiments, and that the arrangement of components may be different than shown, resulting in different data flows while still performing the methods described herein.

FIG. 5 is a schematic, diagrammatic representation, in block diagram form, of at least a portion of an example fraud investigation digital assistant system 500, according to at least one embodiment of the present disclosure.

### Step 1: Data Loading

When an alert is received regarding a particular entity (e.g., a person or organization), the first step is data gathering/preparation. Since the fraud investigation digital assistant system 500 can accept data from local, proprietary, or structured data sources and from external, public, or unstructured data sources, it is first necessary to collect the available data related to an alerted entity. In an example, the structured data sources include two or more of:

A unified data models (UDM) database 505 that includes data for multiple software applications. This data can include an integrated environment for loading, storing and managing customer data for all related software solutions (e.g., Actimize software solutions from Nice, LTD.). Data is loaded once and stored in the UDM database 505, a centralized data repository, serving multiple software solutions. The UDM database 505 msy for example include the following schemas: Customer Data Store (CDS) schema—A long-term repository for the storage of customer data. Software applications may interact and retrieve data directly from the CDS schema. Staging (STG) schema—A temporary repository where data is received and optionally validated. After the data is validated, it can be migrated to the CDS schema for long-term storage, where it can be accessed by software applications. Issues Database (IDB) schema—This stores details regarding issues detected by software applications and other information used for investigation of alerts.

A suspicious activity monitoring (SAM) database 510. This data can include AML and SAM solution-specific transaction data, profiles, etc.

A client due diligence (CDD) database 515. This data can include reference data of the bank's clients (customer data). This database may for example store history for all party-related entities (party, account, loan, etc.). This database may be an internal database that stores data that is updated by the client in the UDM database. The database may include real-time and batch tables.

A watch list filtering (WLX) database 520. This data can include current watch list data, profile data, and metadata about the message screening process. In addition, the database can include auditing information about messages that have been screened, and the screening results.

A risk case management (RCM) database 525. This data can include system internal data such as configuration data, permission related data (roles, organizational structure, etc.), internal metadata (alert types, report types, etc.), and internal objects (alerts, reports, and so on.).

Unstructured data pertaining to the alerted entity can for example include any combination of PDF documents, search engine results (e.g., from Bing or Google), Wikipedia, Google Maps, news sources such as CNN, etc.

In a transformation and embedding step 400, the loaded data is then merged into a single document. However, this document likely will be very large and need to be chunked, vectorized, and stored in the vector store 450.

When the user 135 asks a question 575, the question is sent to the LLM 565. However, the question is also vectorized into an embedding 580 on which a similarity search 585 can be performed against the vectors in the vector store. Those vectors that are calculated to be similar enough are then also fed into the LLM 565 along with the user's question 575. The LLM 565 then produces an answer 585 (e.g., the most relevant answer in the “opinion” of the LLM 565), which is communicated back to the user 135.

FIG. 6 is a schematic, diagrammatic representation, in block diagram form, of at least a portion of an example fraud investigation digital assistant system 600, according to at least one embodiment of the present disclosure. In the example shown in FIG. 6, the chat history 620 of the current conversation and a new question 610 are fed into the LLM 565 to produce a single standalone question that includes more relevant context than the new question 610 by itself. The standalone question itself can then be augmented using a process called retrieval augmented generation (RAG).

Using the embeddings and vector store 450 created during ingestion to look up relevant documents for the answer. In the context of LLMs, retrieval involves identifying and retrieving documents, code snippets, or other data points that are pertinent to the task at hand. This process can be used to help LLMs to effectively respond to user queries, generate creative text formats, and perform various knowledge-intensive tasks. The integration of retrieval into LLM applications offers several compelling advantages:

Enhanced Accuracy and Relevance: By incorporating relevant external data, LLMs can generate more accurate and contextually rich responses.

Personalized Knowledge: Retrieval enables LLMs to access and utilize user-specific data, tailoring their responses to individual needs and preferences.

Expanded Applications: Retrieval empowers LLMs to tackle a broader range of tasks, such as question answering over unstructured data, summarization of long documents, and code generation.

Enhanced Creativity: RAG can stimulate the LLM's creativity by providing inspiration from retrieved documents, leading to more innovative and engaging text formats.

Personalized Responses: RAG enables LLMs to tailor their responses to individual users by incorporating user-specific data into the prompts.

Knowledge sources 410, 420 are turned to embeddings 125 and stored in the vector store 450. When a new question 610 is asked, the new question 610 is first preprocessed to ensure it is in a format that the LLM 565 can understand. This may involve tokenization, normalization, and/or removing irrelevant information. The chat history 620, in the context of the retrieval process, refers to the record of previous conversations between a user and a conversational AI system. This history is typically stored in a database or other persistent storage medium and can be used to improve the performance of the retrieval process.

The new question 610 and the chat history 620 are combined using the large language model (e.g., ChatGPT or another LLM) to generate a standalone question 630 that can be used to retrieve relevant documents from the knowledge base. In an example, the standalone question 630 is concise, informative, and captures the essence of the conversation. The standalone question 630 can be compared against the vector store 450 to retrieve relevant context information 560 about the alerted entity.

When a user submits a query, LangChain transforms it into an embedding as well. The system then utilizes a vector search algorithm (e.g., cosine similarity) to identify documents with embeddings that are most similar to the query embedding. These retrieved documents are then ranked based on their relevance to the query.

Cosine similarity measures the similarity between two vectors of an inner product space. It is measured by the cosine of the angle between two vectors and determines whether two vectors are pointing in roughly the same direction. Given two vectors of attributes, A and B, the cosine similarity, cos(θ), is represented using a dot product and magnitude as:

$$cosine similarity = {S}_{C} ( A , B ) := cos ( θ ) = \frac{A \cdot B}{‖ A ‖ ‖ B ‖} = \frac{{\sum }_{i = 1}^{n} {A}_{i} {B}_{i}}{\sqrt{{\sum }_{i = 1}^{n} {A}_{i}^{2}} {\sum }_{i = 1}^{n} {B}_{i}^{2}} \qquad ( EQN . 1 )$$

where Ai and Bi are the components of vector A & B respectively.

Thus, a relatively larger value (e.g., closer to 1.0) indicates relatively greater similarity, a smaller value (e.g., closer to 0.0) indicates lesser similarity (e.g., orthogonality), while a negative value (e.g., closer to −1.0) indicates diametric opposition. In an example, A may represent data about a source bank, and B may represent data about a target bank.

Thus, the standalone question 630 is fed into an embedding model 310 and compared against embeddings 320 in the vector store 450, to produce (for example) the n most similar embeddings 640, which associated with text chunks.

These top-ranked chunks 560, deemed to be the most relevant to the user's query, are retrieved and returned to the LLM 565 along with the standalone question, enhancing the context for generation. The prompt provided to the LLM 565 can be enriched with various information from the retrieved documents, such as:

Key Concepts: Important concepts and phrases extracted from the retrieved documents can be included in the prompt to guide the LLM's generation.

Relevant Sentences: Sentences that are directly related to the user's query can be incorporated to provide context and inspiration for the LLM 565.

Document References: Links or citations to the retrieved documents can be included to allow the user to verify the information and explore further.

By incorporating retrieved context into the prompts, RAG significantly enhances the accuracy and relevance of LLM-generated responses. The LLM 565 can better understand the user's intent and generate responses that are consistent with the retrieved information, leading to more informative and satisfying interactions.

The LLM 565 processes the augmented prompt and finally generates a response to the user query.

The fraud investigation digital assistant system thus uses the LLM to generate a query, uses the vector store to add relevant information to the query, and uses the LLM, the query, and the relevant information to generate a final result. This triple-encoding process means that the user is not interacting directly with the LLM, but with a sophisticated and highly specialized SAM knowledge engine surrounding the LLM and ensuring that the LLM has all the facts about an alerted entity that are (in terms of cosine similarity) relevant to the alert. Thus, the machine learning algorithms of the LLM are improved by the addition of other learning capabilities, and by being trained on highly specific data that is relevant to SAM and to the clients of a customer.

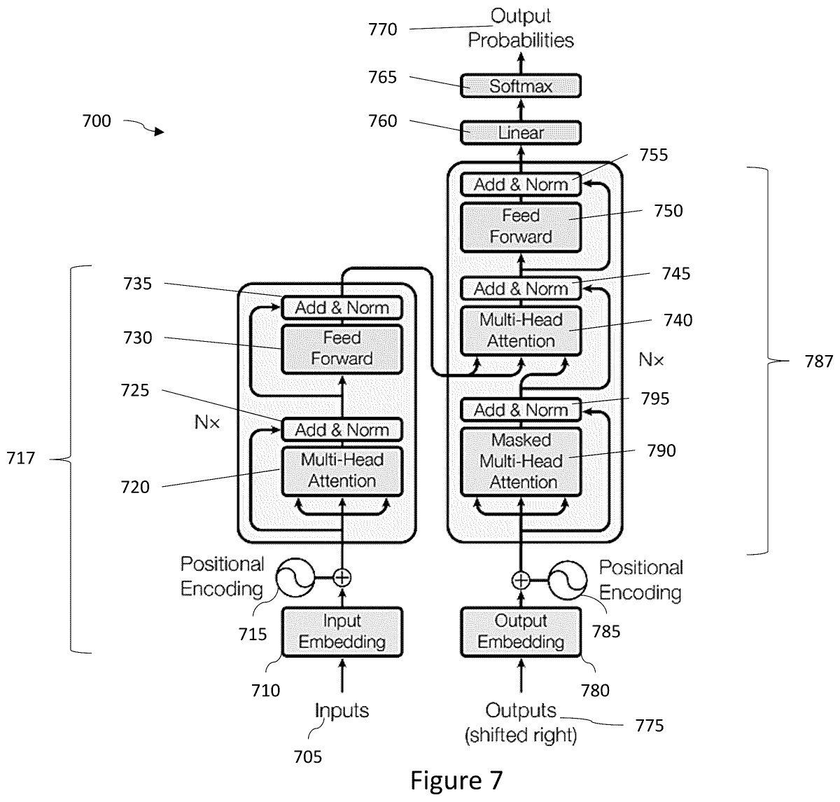

FIG. 7 is a schematic, diagrammatic representation, in block diagram form, of at least a portion of an example large language model (LLM) training subsystem 700, according to at least one embodiment of the present disclosure.

Once documents have been ingested, they can be used to train the LLM. This can be done for example using the langchain.train_chatgpt( ) function.

Many LLMs, such as ChatGPT, internally use a deep learning algorithm called transformer. This algorithm enables ChatGPT to process and generate human-like text by analyzing vast amounts of text data and identifying patterns and relationships between words. It is suitable for use with the systems and methods herein, although various alternatives that exist now or are developed later may also be suitable.

### Step 1: Input Embedding

The input embedding layer 710 converts each word in the input sequence into a vector representation. This representation captures the semantic meaning of the word and allows the model to process it as a numerical entity.

### Step 2: Positional Encoding

Since the Transformer processes the entire input sequence in parallel, it needs a way to represent the order of words. Positional encoding 715 adds a vector to each word embedding, indicating its position in the sequence. This allows the model to understand the relationships between words based on their relative positions.

### Step 3: Encoder

The encoder 717 is the heart of the Transformer, responsible for processing the input sequence and extracting meaningful representations. It consists of multiple encoder layers, each containing two main components:

### a) Multi-Head Attention:

The multi-head attention mechanism 720 allows the encoder to focus on different aspects of the input sequence 705. It projects the input embeddings 710 into multiple query, key, and value vectors, each representing a different “head” of attention. These heads calculate attention scores, indicating the relevance of each word to the current word being processed. After an adding and normalizing step 725, the weighted sum of value vectors, based on attention scores, forms the context vector for the current word.

### b) Feed-Forward Neural Network:

The feed-forward neural network 730 further refines the information captured by the attention mechanism. It may for example consist of two linear layers with a ReLU activation function in between. This non-linear transformation enhances the model's ability to learn complex relationships between words.

The output of each encoder layer is passed as input to the next encoder layer, allowing the model to refine and enrich the representation of the input sequence. An additional adding and normalization step 735 then completes the encoding.

### Step 4: Decoder

The decoder 787 receives the outputs 775, forms output embeddings 780 and positional encoding 785 of the output embeddings, and generates the output sequence one word at a time, using the information extracted from the encoder 717. It also has multiple decoder layers, each containing:

### a) Masked Multi-Head Attention 790:

Similar to the encoder's attention mechanism, the decoder's attention mechanism focuses on relevant parts of the input sequence 705. However, the decoder's attention is masked to prevent it from attending to future words, ensuring that the output is generated in a sequential manner. There is here also an additional and normalization step 795.

### b) Multi-Head Attention Over Encoder Output 740:

In addition to attending to its own output, the decoder also attends to the output 775 of the encoder. This allows the decoder to incorporate information from the entire input sequence 705 while generating the output. There is here also an additional and normalization step 745.

### c) Feed-Forward Neural Network:

The feed-forward neural network 750 in the decoder refines the information captured by the attention mechanisms. There is here also an additional and normalization step 755.

### Step 5: Output Embedding and Softmax

The final step applies a linear transformation 760 to the decoder's output vectors and passes the results through a softmax function 765. The softmax function converts the output vectors into output probabilities 770, indicating the likelihood of each word being the next word in the output sequence.

In this way, using the transformer algorithm, the fraud investigation digital assistant system will be able to answer a vast array of different queries generated by the user. Here is an example of how to train an LLM using ingested documents:

```
import langchain
chatgpt = langchain.train_chatgpt(
  documents=chunked_documents,
  vector_store=vector_store,
  openai_api_key=your_openai_api_key
```

This will train the LLM on the ingested documents. Once training is complete, investigators can use it to ask diverse fraud-related queries regarding the alert and the alerted entity, and receive relevant answers.

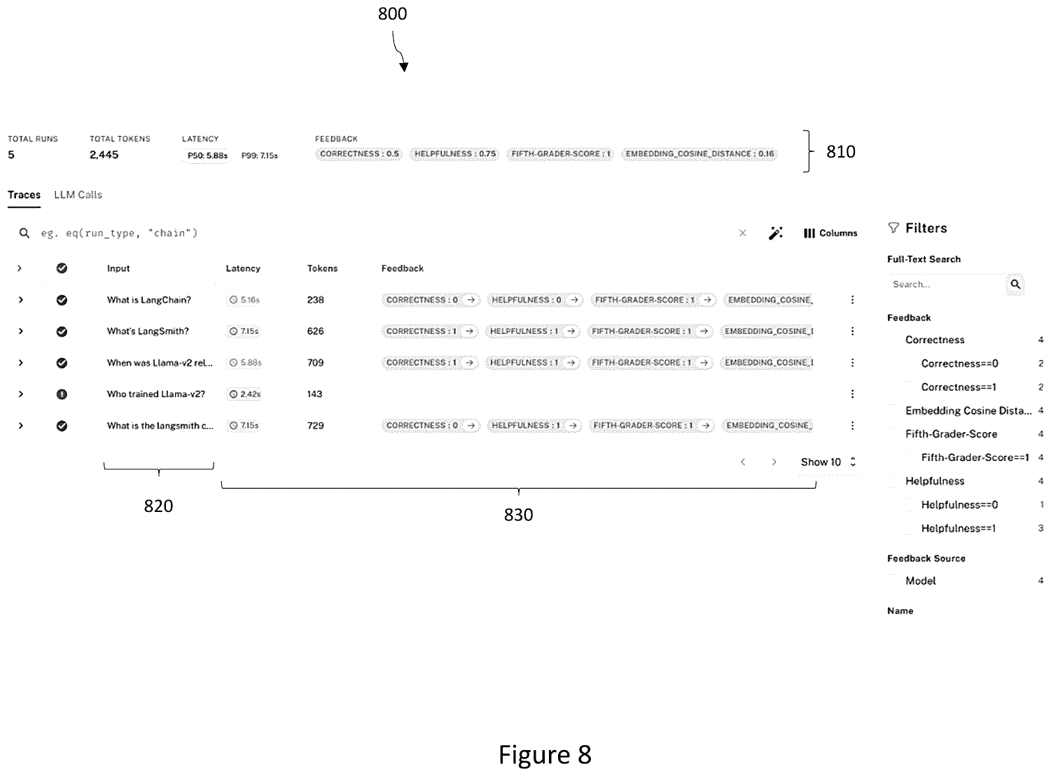

FIG. 8 is a screen display 800 of an example large language model (LLM) training subsystem, according to at least one embodiment of the present disclosure.

Here prompts are tested for some pre-defined parameters. Results are mostly evaluated on the sum of the parameters like correctness, fairness, bias, and helpfulness. In the LLM response, for example, there should not be any toxic words, etc.

The screen display 800 includes a list if input queries 820, a list of response performance metrics 830, and a list of overall performance metrics 810, that can be used to determine the effectiveness of the training of the LLM.

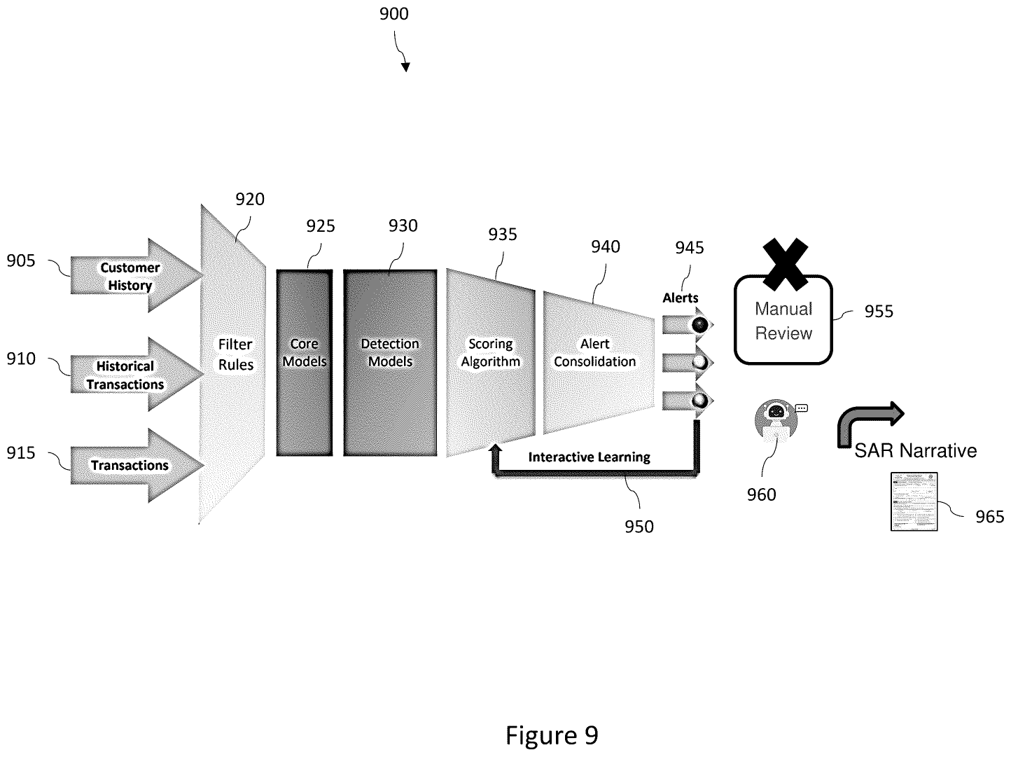

FIG. 9 is a schematic, diagrammatic representation, in block diagram form, of a suspicious activity monitoring (SAM) system 900, according to at least one embodiment of the present disclosure.

Manual review could be replaced by the fraud investigation digital assistant system, which can bring all the information in the SAM infrastructure 900 so that a reviewer can do their end-to-end task in SAM only, without exploring the outside world. The fraud investigation digital assistant system can also generate suspicious activity reports (SARs), or a majority of the content of SARs. The multiple components of the above-noted diagram are further detailed below:

The SAM system or SAM infrastructure 900 includes a filter or data aggregator 920. This component is responsible for the collecting the data required for the alert generation which include customer history 905, transaction data 915, and historical transaction data 910. The filter 920 will filter out a portion of the records which are not a good fit for running the model on. The filter 920 may be adjusted to filter a greater or lesser portion of the records depending on the usefulness of the results passing through.

The SAM system or SAM infrastructure 900 includes Detection Models 925, 930. In the above collected data certain sets of rules will be applied that were configured during client onboarding. Applying the models 925, 930 will yield a score via a scoring algorithm 935. If that score exceeds a preconfigured threshold, it will result in an alert.

Alert consolidation: On one entity in certain time interval there can be multiple issues and their corresponding scores. The alert consolidation module 940 consolidates those scores and generates an alert if it crosses certain thresholds which are configured in the SAM system 900.

Now on each alert, run predictive modeling is used to categorize those alerts into three buckets:
Escalated
Standard
Hibernation

At this point, a human investigator or subject matter expert (SME) becomes involved, to investigate escalated and standard alerts for which they have sufficient time and resources. This manual review step 955 can be eliminated or greatly reduced using the fraud investigation digital assistant system. During the investigation, SME's will use the fraud investigation digital assistant system to ask any queries related to the alerts and/or the alerted entities. At this point, the fraud investigation digital assistant system is already trained on the in-house historical data, but can also utilize learning from the real world as well, since the LLM has already been trained using real-world data. The fraud investigation digital assistant system is capable of searching any information which is available in house, and if something it needs is not available in local databases, it can search through external sources like PDFs, CSVs, and perform web searches. The fraud investigation digital assistant system can then also produce the SAR, or data and narrative portions thereof.

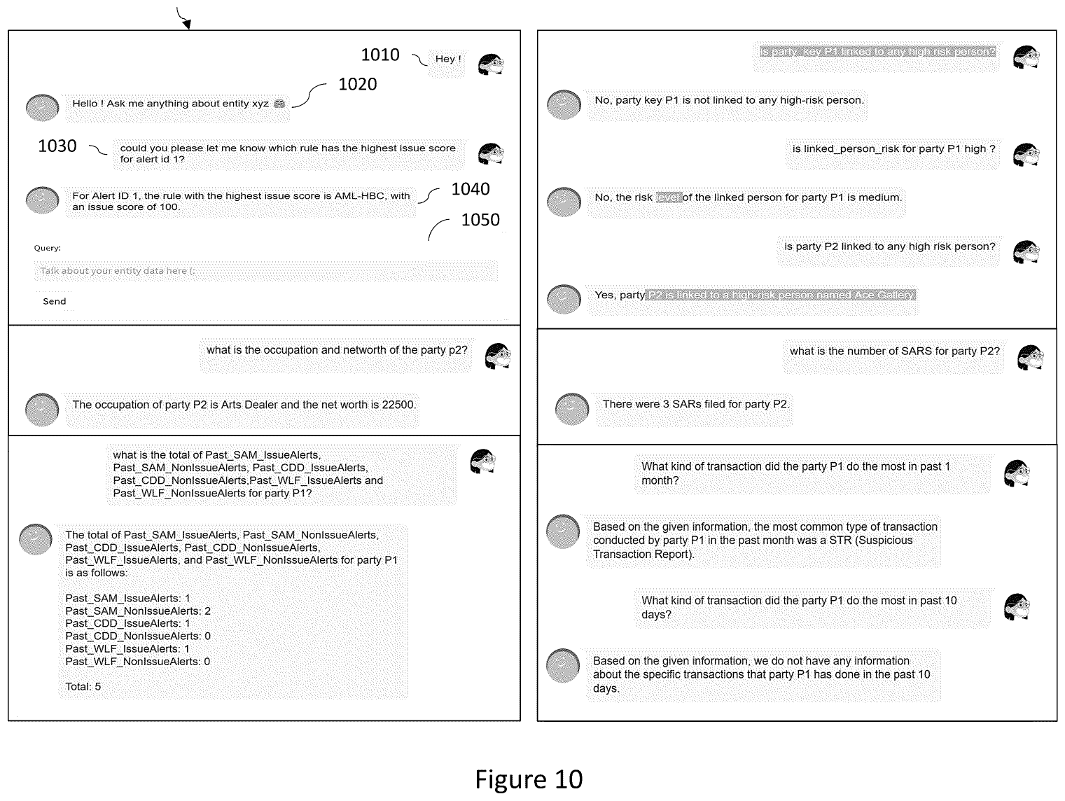

FIG. 10 is a screen display 1000 of an example fraud investigation digital assistant system, according to at least one embodiment of the present disclosure. In the example shown in FIG. 10, the screen display includes a user greeting 1010, LLM greeting 1020, a text entry window 1050, and a number of user queries 1030 and LLM answers 1040. Depending on the implementation, the fraud investigation digital assistant system may filter or reject queries 1030 that are not related to the alerted entity or to the alert itself, in order to ensure that the responses 1040 provide information that is relevant to the investigation.

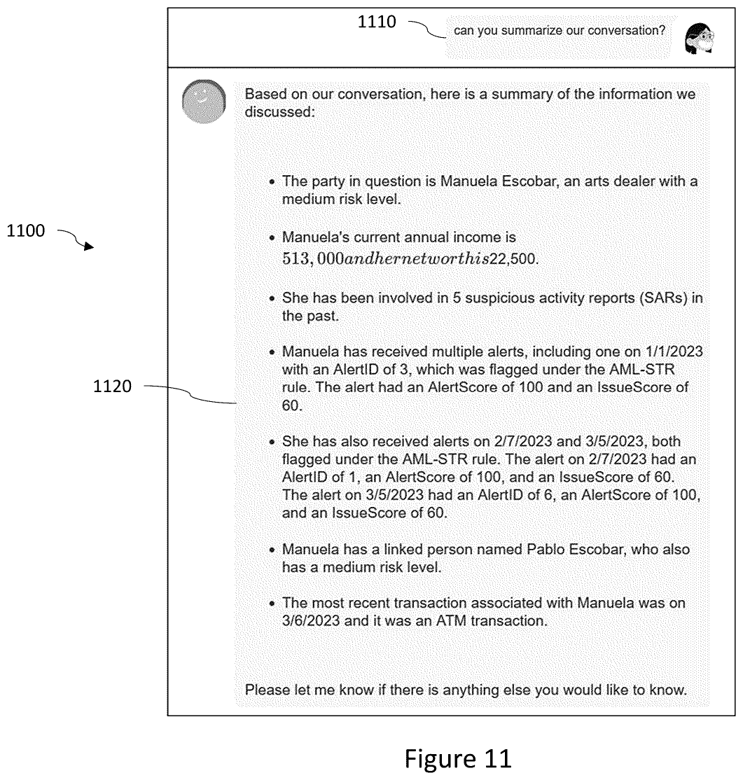

FIG. 11 is a screen display 1100 of an example fraud investigation digital assistant system, according to at least one embodiment of the present disclosure. In the example shown in FIG. 11, the screen display 1100 includes a summary request 1110 and a summary response 1120. The summary response 1120 may for example be a summary, produced by the LLM, of the responses 1040 given in FIG. 10.

The results from the chat can be used to gather and analyze transactional activity and other information about customers. When the fraud investigation digital assistant system is integrated with a third-party tool like Google Maps, news services, etc., external information about customers like negative news, location co-ordinates etc. can be extracted, which helps investigators locate and consolidate information they might not have thought to look for or had time to separately research, which helps improve the quality of the investigation and the informed decisions based on it.

As a results of using the fraud investigation digital assistant system, many of the repetitive manual tasks involved in investigations, like analyzing documents, sending out communications to customers, etc. can be automated. These tasks can be templatized such that the LLM knows how to perform them. The fraud investigation digital assistant system can then create a detailed summary and, based on the template provided, the information can then be used for generating a SAR Narrative. Post investigation, if the alert/customer is deemed suspicious, then a SAR is filed. All the information that is used to build the SAR Narrative will be used in the SAR form for the respective jurisdiction. The fraud investigation digital assistant system can this reduce investigation time by up to 70%, by having all the information, regardless of source, in one place and accessible through the chat window interface, using natural language.

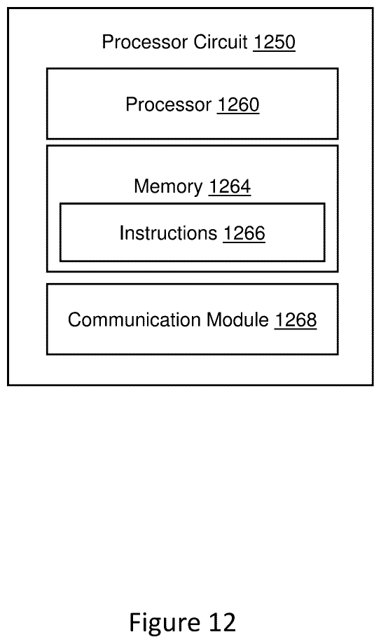

FIG. 12 is a schematic diagram of a processor circuit 1250, according to at least one embodiment of the present disclosure. The processor circuit 1250 may be implemented in the system 500, the system 600, or other devices or workstations (e.g., third-party workstations, network routers, etc.), or on a cloud processor or other remote processing unit, as necessary to implement the method. As shown, the processor circuit 1250 may include a processor 1260, a memory 1264, and a communication module 1268. These elements may be in direct or indirect communication with each other, for example via one or more buses.

The processor 1260 may include a central processing unit (CPU), a digital signal processor (DSP), an ASIC, a controller, or any combination of general-purpose computing devices, reduced instruction set computing (RISC) devices, application-specific integrated circuits (ASICs), field programmable gate arrays (FPGAs), or other related logic devices, including mechanical and quantum computers. The processor 1260 may also comprise another hardware device, a firmware device, or any combination thereof configured to perform the operations described herein. The processor 1260 may also be implemented as a combination of computing devices, e.g., a combination of a DSP and a microprocessor, a plurality of microprocessors, one or more microprocessors in conjunction with a DSP core, or any other such configuration.

The memory 1264 may include a cache memory (e.g., a cache memory of the processor 1260), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an embodiment, the memory 1264 includes a non-transitory computer-readable medium. The memory 1264 may store instructions 1266. The instructions 1266 may include instructions that, when executed by the processor 1260, cause the processor 1260 to perform the operations described herein. Instructions 1266 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The communication module 1268 can include any electronic circuitry and/or logic circuitry to facilitate direct or indirect communication of data between the processor circuit 1250, and other processors or devices. In that regard, the communication module 1268 can be an input/output (I/O) device. In some instances, the communication module 1268 facilitates direct or indirect communication between various elements of the processor circuit 1250 and/or the system 500, 600. The communication module 1268 may communicate within the processor circuit 1250 through numerous methods or protocols. Serial communication protocols may include but are not limited to United States Serial Protocol Interface (US SPI), Inter-Integrated Circuit (I²C), Recommended Standard 232 (RS-232), RS-485, Controller Area Network (CAN), Ethernet, Aeronautical Radio, Incorporated 429 (ARINC 429), MODBUS, Military Standard 1553 (MIL-STD-1553), or any other suitable method or protocol. Parallel protocols include but are not limited to Industry Standard Architecture (ISA), Advanced Technology Attachment (ATA), Small Computer System Interface (SCSI), Peripheral Component Interconnect (PCI), Institute of Electrical and Electronics Engineers 488 (IEEE-488), IEEE-1284, and other suitable protocols. Where appropriate, serial and parallel communications may be bridged by a Universal Asynchronous Receiver Transmitter (UART), Universal Synchronous Receiver Transmitter (USART), or other appropriate subsystem.

External communication (including but not limited to software updates, firmware updates, preset sharing between the processor and central server, or other communications) may be accomplished using any suitable wireless or wired communication technology, such as a cable interface such as a universal serial bus (USB), micro USB, Lightning, or Fire Wire interface, Bluetooth, Wi-Fi, ZigBee, Li-Fi, or cellular data connections such as 2G/GSM (global system for mobiles), 3G/UMTS (universal mobile telecommunications system), 4G, long term evolution (LTE), WiMax, or 5G. For example, a Bluetooth Low Energy (BLE) radio can be used to establish connectivity with a cloud service, for transmission of data, and for receipt of software patches. The controller may be configured to communicate with a remote server, or a local device such as a laptop, tablet, or handheld device, or may include a display capable of showing status variables and other information. Information may also be transferred on physical media such as a USB flash drive or memory stick.

As will be readily appreciated by those having ordinary skill in the art after becoming familiar with the teachings herein, the fraud investigation digital assistant system advantageously provides an ability to compile data about an alerted entity from disparate sources, in real time or near-real time, receive queries in a natural language format, and respond to the queries with natural language answers focused on the alert, the alerted entity, and other entities associated with the alerted entity.

A number of variations are possible on the examples and embodiments described above. For example, the technology described herein may be applied to other types of fraud investigation besides anti-money-laundering (AML), including but not limited to wire fraud, check fraud, credit card fraud, bank and brokerage account fraud, suspicious activity monitoring, and human trafficking.

Accordingly, the logical operations making up the embodiments of the technology described herein are referred to variously as operations, steps, objects, elements, components, or modules. Furthermore, it should be understood that these may occur or be performed or arranged in any order, unless explicitly claimed otherwise or a specific order is inherently necessitated by the claim language.

All directional references e.g., upper, lower, inner, outer, upward, downward, left, right, lateral, front, back, top, bottom, above, below, vertical, horizontal, clockwise, counterclockwise, proximal, and distal are only used for identification purposes to aid the reader's understanding of the claimed subject matter, and do not create limitations, particularly as to the position, orientation, or use of the fraud investigation digital assistant system. Connection references, e.g., attached, coupled, connected, joined, or “in communication with” are to be construed broadly and may include intermediate members between a collection of elements and relative movement between elements unless otherwise indicated. As such, connection references do not necessarily imply that two elements are directly connected and in fixed relation to each other. The term “or” shall be interpreted to mean “and/or” rather than “exclusive or.” The word “comprising” does not exclude other elements or steps, and the indefinite article “a” or “an” does not exclude a plurality. Unless otherwise noted in the claims, stated values shall be interpreted as illustrative only and shall not be taken to be limiting.

The above specification, examples and data provide a complete description of the structure and use of exemplary embodiments of the fraud investigation digital assistant system as defined in the claims. Although various embodiments of the claimed subject matter have been described above with a certain degree of particularity, or with reference to one or more individual embodiments, those skilled in the art could make numerous alterations to the disclosed embodiments without departing from the spirit or scope of the claimed subject matter.

Still other embodiments are contemplated. It is intended that all matter contained in the above description and shown in the accompanying drawings shall be interpreted as illustrative only of particular embodiments and not limiting. Changes in detail or structure may be made without departing from the basic elements of the subject matter as defined in the following claims.

What is claimed is:

1. A system adapted to automatically report the trustworthiness of an entity, the system comprising:
a processor and a computer readable medium operably coupled thereto, the computer readable medium comprising a plurality of instructions stored in association therewith that are accessible to, and executable by, the processor, to perform operations which comprise:
receiving unstructured data pertaining to an entity from a plurality of public sources;
receiving structured data pertaining to the entity from at least two of:
a database comprising data for multiple software applications;
a suspicious activity monitoring (SAM) database;
a client due diligence (CDD) database;
a watch list filtering (WLX) database; or
a risk case management (RCM) database;
with a merging engine, merging the structured data and the unstructured data into a single document;
with a semantic analyzer, splitting the single document into a plurality of chunks;
with an embedding model, based on the plurality of chunks, creating a plurality of embeddings, each embedding corresponding to a chunk of the plurality of chunks;
storing the plurality of embeddings in a vector store;
receiving a natural language user query regarding trustworthiness of the entity;
with the embedding model, converting the natural language user query to a query embedding;
based on the query embedding and a similarity calculation, fetching a relevant embedding from the vector store;
with a large language model (LLM), based on the query embedding, the fetched relevant embedding, and the chunk corresponding to the fetched embedding, generating a query response regarding the trustworthiness of the entity; and
communicating the query response to the user.

2. The system of claim 1, wherein the similarity calculation comprises a cosine similarity calculation.

3. The system of claim 1, wherein the entity comprises a person.

4. The system of claim 1, wherein the public sources are accessed over the Internet.

5. The system of claim 1, wherein the plurality of public sources comprises at least one of a document, a website, an encyclopedia, a database, a search engine, a map, a weather report, or a news report.

6. The system of claim 1, wherein the structured data comprises personally identifying information (PII) about the entity.

7. The system of claim 1, further comprising a chat history, wherein generating the query response regarding the trustworthiness of the entity involves the chat history.

8. The system of claim 7, further comprising:
with the LLM, based on the user query and the chat history, constructing a standalone question; and
substituting the standalone question for the user query.

9. The system of claim 1, wherein the query response comprises a natural language response.

10. The system of claim 1, wherein the operations further comprise:
based on the query embedding and a similarity calculation, fetching a plurality of relevant embedding from the vector store; and
with the large language model (LLM), based on the query embedding, the fetched plurality of relevant embeddings, and the respective chunks corresponding to the fetched embeddings, generating the query response regarding the trustworthiness of the entity,
wherein the query response comprises a summary of the respective chunks.

11. A computer-implemented method adapted to automatically generate and validate rules for monitoring suspicious activity, the method comprising:
receiving unstructured data pertaining to an entity from a plurality of public sources;
receiving structured data pertaining to the entity from at least two of:
a database comprising data for multiple software applications;
a suspicious activity monitoring (SAM) database;
a client due diligence (CDD) database;
a watch list filtering (WLX) database; or
a risk case management (RCM) database;
with a merging engine, merging the structured and unstructured data into a single document;
with a semantic analyzer, splitting the single document into a plurality of chunks;
with an embedding model, based on the plurality of chunks, creating a plurality of embeddings, each embedding corresponding to a chunk of the plurality of chunks;
storing the plurality of embeddings in a vector store;
receiving a natural language user query regarding trustworthiness of the entity;
with the embedding model, converting the natural language user query to a query embedding;
based on the query embedding and a similarity calculation, fetching a relevant embedding from the vector store;
with a large language model (LLM), based on the query embedding, the fetched relevant embedding, and the chunk corresponding to the fetched embedding, generating a query response regarding the trustworthiness of the entity; and
communicating the query response to the user.

12. The method of claim 11, wherein the similarity calculation comprises a cosine similarity calculation.

13. The method of claim 11, wherein the entity comprises a person.

14. The method of claim 11, wherein the public sources are accessed over the Internet.

15. The method of claim 11, wherein the plurality of public sources comprises at least one of a document, a website, an encyclopedia, a database, a search engine, a map, a weather report, or a news report.

16. The method of claim 11, wherein the structured data comprises personally identifying information (PII) about the entity.

17. The method of claim 11, further comprising a chat history, wherein generating the query response regarding the trustworthiness of the entity involves the chat history.

18. The method of claim 17, further comprising:
with the LLM, based on the user query and the chat history, constructing a standalone question; and
substituting the standalone question for the user query.

19. The method of claim 11, wherein the query response comprises a natural language response.

20. The method of claim 11, further comprising:
based on the query embedding and a similarity calculation, fetching a plurality of relevant embedding from the vector store; and
with the LLM, based on the query embedding, the fetched plurality of relevant embeddings, and the respective chunks corresponding to the fetched embeddings, generating the query response regarding the trustworthiness of the entity,
wherein the query response comprises a summary of the respective chunks.
